(19) United States
(12) Patent Application Publication
(10) Pub. No.: US 2002/0152599 A1
(43) Pub. Date: Oct. 24, 2002

(54) Device for extracting a broken screw from a work piece and method of operating the same

(76) Inventor: Chun-Teng Pai, Tainan Hsien (TW)

Correspondence Address: Thomas M. Freiburger, 650 California St., 25th Floor, San Francisco, CA, 94108, US

(21) Appl. No.: 09/839,798

(22) Filed: Apr. 19, 2001

(51) Int. Cl. B23P 19/06

(52) U.S. Cl. 29/426.1

(57) ABSTRACT

A screw extractor usable for an ordinary chisel is reversely rotatable and can be easily cut into the broken surface of said screw, and by turning it in reverse direction together with said broken screw and relevantly shaking said screw extractor during operation, said broken screw can be easily loosened and removed.

### BACKGROUND OF THE INVENTION

1. Field of the Invention

The present invention relates to a device for extracting a broken rightwardly rotating screw from a work piece and method of operating the same, in more particularly, to device which turns in reverse direction with the broken screw to extract it and the method of operating the same.

2. Description of the Prior Art

Screws are important subordinative components in mechanical structures. Numerous screws of various sizes and types are consumed in either large or small workshops. It is a common experience that a screw would break during installation. If the head portion of a broken screw still remains protruding out of a screw fitting hole, it is not difficult to remove the broken screw away with a plier or a pincette. In the case a broken screw 1 is deeply inserted into the screw hole and stuck there, it will be embarassing the worker to pick it up. One of the methods for solving this problem is shown in FIG. 1 where a larger chisel 3 is used to chisel the screw 1 and the inner wall surface of the screw hole 2 so as to remove the broken screw 1 away. After that a larger screw has to be employed to fit into the widened screw fitting hole 2. By so, quality of a finished product might be slightly degraded from the originally expected degree and even affect appearance and strength of the product. In the worst case, the chisel 3 which rotates rightwardly in the same direction with the broken screw 1 might accompany the result that the broken screw 1 is more deeply buried into the screw fitting hole 2. Another remedy for the broken screw 1 is shown in FIG. 2 wherein a chisel with a very acute head is employed to bore a small hole on the broken cross section of the screw 1 before applying an auxiliary tool 4 to pick up the broken screw 2 carefully by inserting its pointed head into that small hole bored in the broken screw 1. In spite of the fact that damage to the wall of the screw fitting hole 2 can be evaded in rescuing the broken screw 1, the work is quite tedious and bothersome, and is not effective to a broken screw which gets stuck too tightly and deeply in the screw fitting hole 2.

### SUMMARY OF THE INVENTION

Therefore, an invention devoting to resolving aforesaid disadvantages of current device and method for removing a broken screw from a work piece is definitely necessary, and through long time of study and experiments, the present invention has come out which is able to eliminate the disadvantages of the conventional techniques.

It is an object of the present invention to provide a device for extracting a broken screw from a work piece, wherein the device is a reversely rotatable screw extractor which is able to drive a broken screw to rotate in reverse direction and be removed away, and in a normal case, this screw extractor is usable as a general chisel.

It is another object of the present invention to provide a method for using this reversely rotatable screw extractor to drive a broken screw to rotate in reverse direction and be removed away.

The screw extractor having the above mentioned advantages usable for an ordinary chisel provided by the present invention, is reversely rotatable and can be easily cut into the broken surface of a broken screw, and by turning it in reverse direction together with the broken screw and relevantly shaking the screw extractor during operation, the broken screw can be easily loosened and removed.

### BRIEF DESCRIPTION OF THE DRAWINGS

The above objects, advantages and operational principles of the present invention will become more apparent by describing in detail the preferred embodiment of the present invention with reference to the attached drawings in which:

FIG. 1 is a schematic view showing a conventional method of removing a broken screw from a work piece;

FIG. 2 is a schematic view showing another conventional method of removing a broken screw from a work piece;

FIG. 3 is a schematic view of the device for extracting a broken screw from a work piece according to the present invention;

FIG. 4 is a schematic view illustrating the method of extracting a broken screw from a work piece using the device of FIG. 3 according to the present invention;

FIG. 5 is a schematic view illustrating how the broken screw is removed with the aid of relevant auxiliary tools according to the present invention.

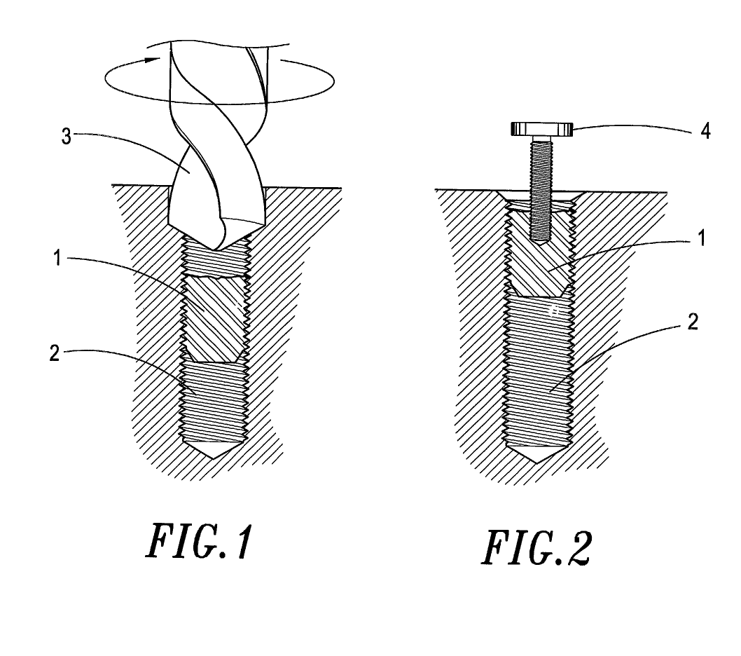

### DETAILED DESCRIPTION OF THE PREFERRED EMBODIMENT

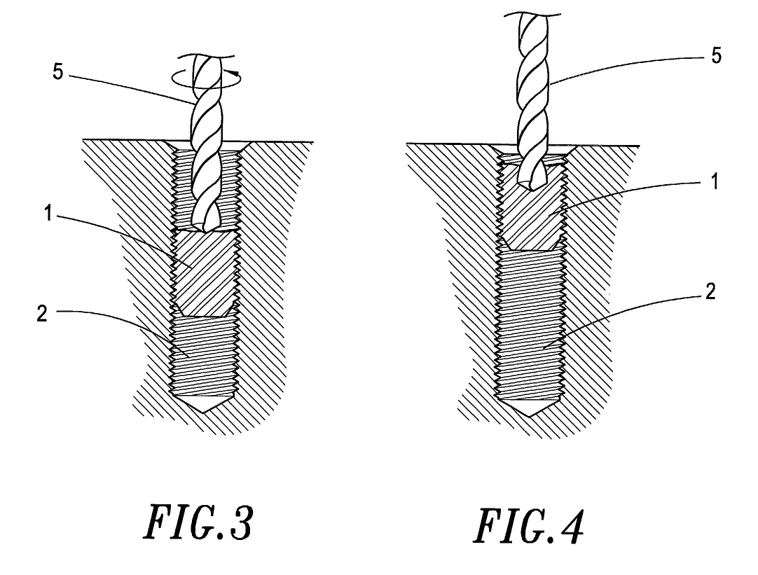

FIG. 3 is a schematic view of the device for extracting a broken screw from a work piece according to the present invention. Referring to FIG. 3, this device is a screw extractor 5 which rotates in reverse direction against that of the broken screw 1 screwed into the screw fitting hole 2. By so, the screw extractor 5 is just suitable for retracting and removing the broken screw 1 out of the screw hole 2 by turning it in loosening direction.

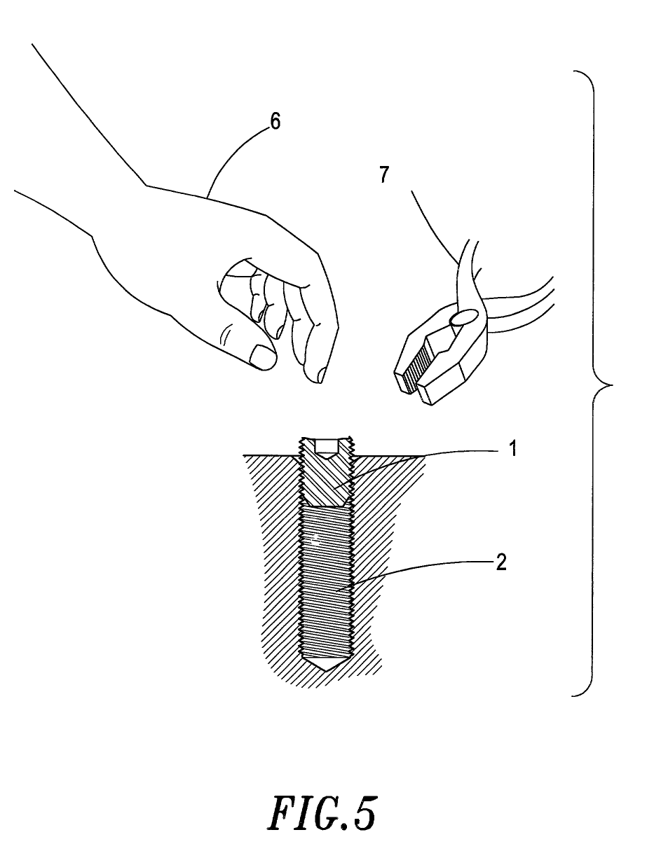

FIG. 4 is a schematic view illustrating the method of extracting a broken screw from a work piece with the screw extractor 5 shown in FIG. 3. Referring to FIGS. 3 and 4, the steps of extracting the broken screw 1 from the screw fitting hole 2 by means of the screw extractor 5 of the present invention include: selecting the reversely rotating screw extractor 5 having a fine and acute tip; turning the screw extractor 5 in the reverse direction so as to carefully bore into the head of the broken screw 1 with a relevant distance; retreating and shaking occasionally, the screw extractor 5 slowly from the broken screw 1 so as to make room for the broken screw 1 to retract from the screw hole 2 while being turned in reverse direction; repeating the steps 2 and 3 until the broken screw 1 appears partly out of the screw fitting hole 2; and continuing turning the screw extractor 5 until the broken screw 1 entirely leaves the screw fitting hole 2, and removing it away by operator's hand, or with auxiliary tools, for example, a plier or a pincette.

After having finished reading over the above detailed description of the present invention, one may be clearly aware of that the present invention has several features which any conventional means and method can not attain, and are as follows: 1. high efficiency in operation, 2. No fear of causing damage to any main or component parts of the work piece, 3. Versatile usage of the screw extractor, such as a chisel, 4. No special need for training operators.

Now, those who are skilled in the art will readily perceive how to modify the invention. Therefore, the appended claims are to be construed to cover all equivalent structures which fall within the true scope and spirit of the invention.

What is claimed is:

1. A device for extracting a broken screw from a work piece is a screw extractor characterized in that it turns in reverse direction to a normal turning direction of a screw when being operated to extract said broken screw from a screw fitting hole.

2. The method of extracting a broken screw from a work piece with the screw extractor of claim 1, comprising the steps of:
a. using said screw extractor having a fine and acute tip;
b. turning said screw extractor in the reverse direction so as to carefully bore into the head of said broken screw with a relevant distance;
c. retreating and shaking occasionally said screw extractor slowly from said broken screw so as to make room for said broken screw to retract out of said screw fitting hole while being turned in reverse direction;
d. repeating said steps 2 and 3 until said broken screw appears partly out of said screw fitting hole;
e. continuing turning said screw extractor until said broken screw is entirely leaving said screw fitting hole, and then removing it away by operator's hand or with auxiliary tools.
